(19) United States
(12) Patent Application Publication
(10) Pub. No.: US 2007/0215362 A1
(43) Pub. Date: Sep. 20, 2007

(54) Fire sprinkler system

(75) Inventor: Harold J. Rodgers, Riverside, CA (US)

Correspondence Address: KUTAK ROCK, LLP, 1801 CALIFORNIA STREET, SUITE 3100, DENVER, CO, 80202-2626, US

(73) Assignee: Fire Sprinkler System, Inc.

(21) Appl. No.: 11/384,761

(22) Filed: Mar. 20, 2006

(51) Int. Cl. A62C 2/00

(52) U.S. Cl. 169/46; 169/37; 169/42

(57) ABSTRACT

A fire sprinkler system includes a plurality of sprinkler heads disposed at predetermined positions within a structure. Water in the system, on the system side, is isolated by a solenoid-activated valve from water on the municipal or street side. The water pressure on the system side is maintained at a lower pressure than the water pressure on the municipal side. In one embodiment, the sprinkler heads include a sprinkler head casing mated with a cover plate. The cover plate separates from the casing at a specified temperature. A switch compressed between the casing and the cover plate is activated by the separation of the cover plate. Activation of the switch opens the solenoid-activated valve of the fire sprinkler system, thereby releasing water at street pressure into the system.

### BACKGROUND

Fire sprinkler systems have been installed in commercial and industrial buildings for years and are, in fact, mandated by fire safety codes in virtually every jurisdiction. More recently, concerns for enhanced home safety and a desire to minimize property damage caused by residential fires have lead to the installation of residential fire sprinkler systems in an increasing number of homes. However, the plastic pipe used in these systems to transport water is susceptible to damage during activities that require drilling, hammering or cutting into dry wall. Such activities may include installation of cable TV or alarm systems, picture hanging, lighting upgrades and the like. When a leak or break in a water line occurs, there is usually a delay in locating the shut-off valve on the main supply line, which results in flooding of the wall space and adjoining areas. The average cost of a residential flood is in excess of $50,000.

“Dry systems” attempt to avoid accidental flooding by filling the fire sprinkler system with compressed air; but, in an emergency, the time required to displace the compressed air results in a delay in delivering water to the fire. To compensate for the delay, dry systems are designed to deliver more water than an average fire sprinkler system. Therefore, a pipe with a large diameter is required, thereby increasing both the cost of the system and the likelihood of inadvertent damage to the pipe occurring, as described above. Although a puncture in a dry system would not lead to flooding, a portion of drywall must be removed so that the section of damaged pipe can be replaced. Moreover, systems that are delayed in delivering water may usually only be used in residences of less than 3500 square feet, where a limited amount of oxygen is available to fuel a spreading fire. Dry systems are, therefore, not suitable for large residences, townhomes or apartment complexes.

In addition to their practical limitations, fire sprinkler systems often require the use of commercial sprinkler heads that are considered unsightly and undesirable in many residences. Hence, there is a need for a fire sprinkler system that delivers adequate quantities of water or other fire suppression agents efficiently and in a timely manner, without unnecessary risk to property.

### SUMMARY

The fire sprinkler system herein disclosed advances the art and overcomes problems articulated above by providing a system that dispenses water or other fire retardant at the appropriate moment, while simultaneously limiting damage resulting from inadvertent system operations.

In particular, and by way of example only, according to an embodiment, a fire sprinkler system is provided, including: a plurality of sprinkler heads disposed at pre-selected locations in a structure; means for delivering water from a main supply line to the plurality of sprinkler heads; means for selectively isolating water in the system from water in the main supply line; means for relieving a water pressure in the system so that the water pressure in the system is less than a water pressure in the main supply line when the water in the system is isolated from the water in the main supply line; and, means for triggering a release of water from the main supply line to the system in response to heat generated by a fire in the structure.

In another embodiment, a fire sprinkler system is provided including: a plurality of sprinkler heads disposed at pre-selected locations in a structure; piping for delivering water to the plurality of sprinkler heads; a valve positioned between the piping and a main supply line, for selectively isolating water in the main supply line from water in the system; a pressure control mechanism for controlling a water pressure in the system, wherein the water pressure in the system is less than a water pressure in the main supply line when the water in the main supply line is isolated from the water in the system; and, a release mechanism for triggering a release of water from the main supply line into the system in response to heat generated by a fire in the structure.

In yet another embodiment, a method for extinguishing a fire is provided, including: charging a fire extinguishing system in the structure with water, wherein a water pressure in the fire extinguishing system is less than a water pressure in a main supply line; selectively isolating water in the fire extinguishing system from water in the main supply line; maintaining the water pressure in the fire extinguishing system at a predetermined value; and releasing water from the main supply line into the fire extinguishing system in response to heat generated by a fire in the structure.

In still another embodiment, a method for extinguishing a fire in a structure is provided, including: charging a fire extinguishing system in the structure with a fire suppression agent, wherein a static pressure of the fire suppression agent in the fire extinguishing system is less than a static pressure of fire suppression agent in a main supply line; selectively isolating the fire suppression agent in the fire extinguishing system from the fire suppression agent in the main supply line; maintaining the static pressure of the fire suppression agent in the fire extinguishing system at a predetermined value; and, releasing fire suppression agent from the main supply line into the fire extinguishing system in response to heat generated by a fire in the structure.

### BRIEF DESCRIPTION OF DRAWINGS

FIG. 1 shows a fire sprinkler system in accord with an embodiment.

FIG. 2 illustrates a sprinkler head and related components, in accord with an embodiment.

### DETAILED DESCRIPTION

The disclosed instrumentalities advantageously provide a fire sprinkler system for use in both commercial and residential structures. The embodiments disclosed herein not only serve to eliminate the time delay, inherent in certain prior art systems, in the delivery of water to a fire, but also minimize potential water damage to a structure caused by damage to the system or an accidental system discharge. Additionally, a system is disclosed which both conceals unsightly sprinkler head components and permits the system to come to full street pressure either concurrently with or just prior to sprinkler head activation.

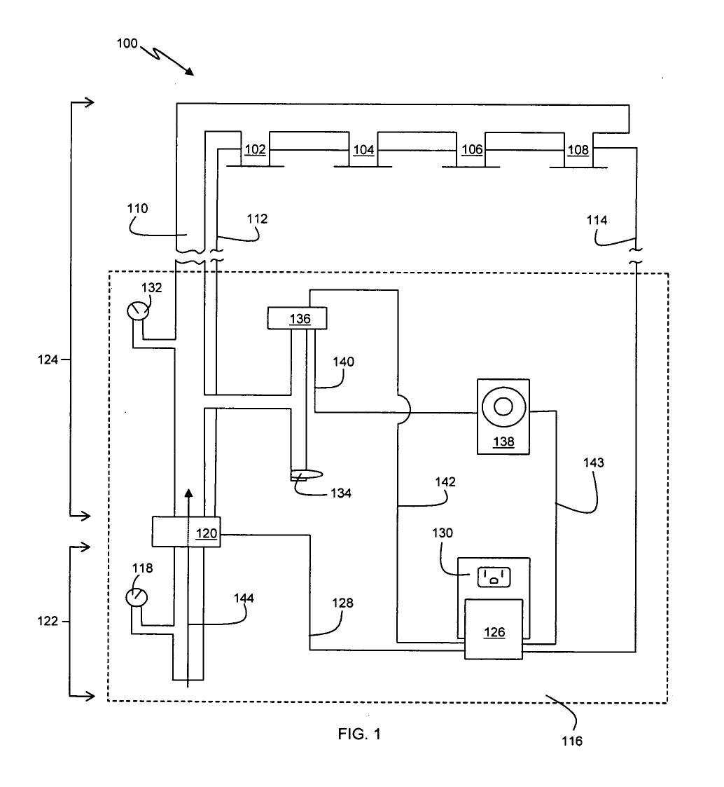

FIG. 1 shows a fire sprinkler system 100 having a plurality of sprinkler heads, of which sprinkler heads 102, 104, 106 and 108 are exemplary. The sprinkler heads 102-108 are disposed or spaced within a structure (not shown) at certain pre-selected distances from one another. The location and spacing of sprinkler heads 102-108 are normally determined by the size of the installation environment and/or fire code regulations.

Sprinkler heads 102-108 are in fluid communication with the remainder of system 100 via a pipe 110. Pipe 110 may be fabricated from a variety of materials including metals (e.g., copper, brass), polymers (e.g., polyvinyl chloride (PVC), chlorinated polyvinyl chloride (CPVC)), or combinations thereof. Polymeric pipe is typically used because it is less expensive and less labor intensive to install than metal pipe. Similarly, sprinkler heads 102-108 are in electrical contact with one or more elements of system 100 via electrical lines, of which electrical lines 112 and 114 are exemplary.

Fire sprinkler system 100 includes numerous electrical and plumbing components which may be contained for convenience of access, by way of example, in a wall-mounted control panel 116 (shown in phantom) suitably positioned in or near the installation environment. It can be appreciated that all system 100 components need not be contained in a single control panel 116, and that components may be positioned throughout the installation environment to facilitate efficient system 100 operation.

As shown in FIG. 1, a pressure gauge 118 is mounted to pipe 110 to show the pressure of water received into system 100, for example, from a municipal authority, also known in the art as the “street pressure”. A solenoid-activated isolation valve 120 is positioned to isolate water on the municipal (upstream) side 122 of valve 120 from water on the system (downstream) side 124. Solenoid-activated valve 120 receives power, for example, from a transformer 126 via an electrical line, e.g. line 128. Transformer 126 converts electricity from a 120 V power outlet 130, and provides the electricity to a number of electrical components of system 100.

Still referring to FIG. 1, a pressure gauge 132 mounted to pipe 110 shows the water pressure on the system or downstream side 124. A pressure relief valve 134 is in fluid communication with pipe 110, for allowing water to flow out of system 100, thereby adjusting the water pressure in the system 100. In at least one embodiment, pressure relief valve 134 is a manually operated valve. In yet another embodiment, valve 134 is electronically controlled.

Positioned “in line” with pipe 110 and pressure relief valve 134 is a high/low pressure switch 136. High/low pressure switch 136 triggers an audible alarm from a piezoelectric switch 138 if the water pressure on the system side 124 drops below a set level (e.g., 20-30 psi below the normal system side 124 pressure), or rises above a set level (e.g., 5-10 psi below the municipal side 122 water pressure). For example, a high pressure alarm may be triggered by a failure or emergency opening of solenoid-activated valve 120. As shown, high/low pressure switch 136 is in electrical communication with piezoelectric switch 138 via electrical line 140, and is connected to transformer 126 via electrical line 142. Likewise, switch 138 is connected to transformer 126 via electrical line 143. Alarm mechanisms may include, without limitation, a light, bell and/or direct link to a fire station or monitoring service.

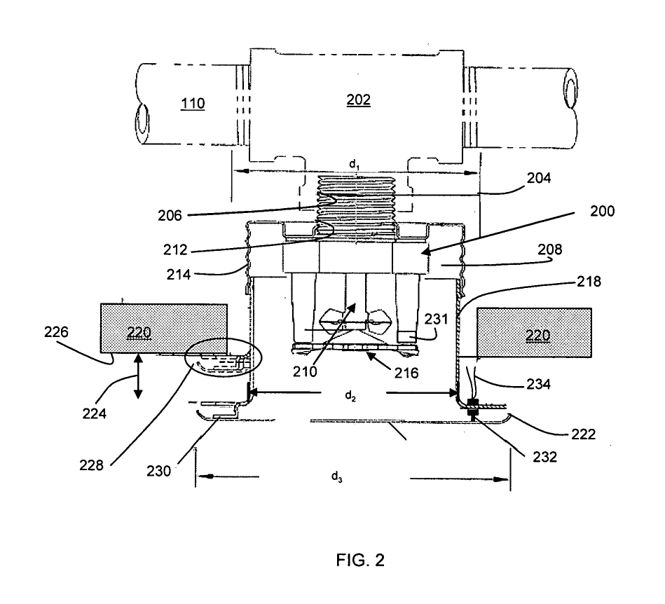

Referring now to FIG. 2, a sprinkler head 200 and related components are shown in greater detail. However, those skilled in the art will appreciate that sprinkler head 200 is shown for purposes of illustration only, and other sprinkler head configurations may be used, as well, without departing from the scope of the subject disclosure. In one embodiment, sprinkler head 200 is a concealed sprinkler head. As shown, sprinkler head 200 may connect to pipe 110 via a T-joint 202. In at least one embodiment, sprinkler head 200 has a threaded male connector 204 that interfaces with a threaded female channel 206 of T-joint 202. When properly installed, the threads of male connector 204 engage with female channel 206 to secure sprinkler head 200 to T-joint 202, and hence pipe 110.

A cylindrical sleeve 208 surrounds a portion of male connector 204, as well as a section of a sprinkler assembly 210 closest to T-joint 202. Male connector 204 fits through an aperture 212 in sleeve 208 such that connector 204 is oriented toward female channel 206. As shown in FIG. 2, a wall 214 of sleeve 208 extends toward a dispensing end 216 of sprinkler assembly 210. Wall 214 interfaces with, and circumferentially surrounds a portion of, a sprinkler head casing 218. Wall 214 may be ribbed to hold sprinkler head casing 218 in place, and to allow for adjustment of sprinkler head casing 218 vertically toward or away from pipe 110.

As system 100 is assembled, sprinkler head casing 218 is inserted into a hole in ceiling 220. Typically, the diameter “d₁” of the hole is slightly larger than the diameter “d₂” of casing 218. A cover plate 222, having a diameter “d₃” equal to or greater than “d₁”, is connected to the end of sprinkler head casing 218 furthest from pipe 110. In this manner, cover plate 222 conceals the components of sprinkler head 200 to provide a discrete and aesthetically acceptable appearance. Sprinkler head casing 218 may be adjusted vertically, as represented by arrow 224, to position cover plate 222 a desired distance away from a bottom surface 226 of ceiling 220. As shown in phantom in section 228 of FIG. 2, sprinkler head casing 218 may be positioned substantially flush with surface 226. Alternatively, casing 218 may be spaced some distance away from surface 226.

Cover plate 222 is mated with sprinkler head casing 218 by a plurality of temperature sensitive joints which may be solder joints, e.g. joint 230. The metal used to form solder joint 230 typically has a melting point in the temperature range of about 110° F.-185° F., which permits solder joint 230 to soften and melt in response to heat generated by a fire in the structure in which sprinkler head 200 is installed. It can be appreciated that solder joint 230 is but one of many temperature sensitive, mechanical or electromechanical joints or connections well known in the art. One or more such temperature sensitive connections may be used without departing from the scope of the present disclosure. For example, bismuth alloys and glass bulbs have been used as pressure seals in fire sprinkler heads with activation temperatures between about 135-286° F.

As shown in FIG. 2, sprinkler head 200 may include a temperature monitor 231 for sensing a temperature in the immediate vicinity of sprinkler head 200. The location of temperature monitor 231 in FIG. 2 is but one embodiment, and it can be appreciated that temperature monitor 231 may be mounted in any of a number of locations in and around sprinter head 200 without departing from the scope of this disclosure.

In at least one embodiment, a switch 232 is compressed between sprinkler head casing 218 and cover plate 222. When switch 232 is compressed and connected to solenoid-activated valve 120, via wires 234, a closed circuit is created with solenoid-activated valve 120. In yet another embodiment, a direct electrical connection closes the circuit between cover plate 222 and valve 120. The connection may be formed as part of solder joint 230, and need not include a switch, such as switch 232.

Considering now the operation of fire sprinkler system 100, initially the system 100 may be charged with water. Water on the system side 124 is typically maintained at a lower pressure than water on the municipal side 122. The water pressure on system side 124 may be adjusted to the desired level, typically in the range of 20-30 psi below street pressure, for example, by removing water through valve 134.

Concurrent with the charging of system 100, solenoid-activated valve 120 is powered closed, thereby isolating the water in system side 124 from the water in municipal side 122. Final electrical connections are made between components (e.g. transformer 126, piezoelectric switch 138, etc.), and system 100 is ready for use. Once charged and operational, system 100 remains in a ready state until a triggering event, such as a fire in the structure.

In the event of a fire, the temperature in the structure will wise commensurate with the size and growth of the fire. As the temperature approaches a critical temperature, e.g. the melting point of solder joint 230, the connection between cover plate 222 and sprinkler head casing 218 begins to fail. As solder joint 230 weakens, the force of gravity causes cover plate 222 to separate from and potentially fall away from sprinkler head casing 218. The partial or complete separation of cover plate 222 from sprinkler head casing 218 opens switch 232 and terminates the electrical connection between switch 232 and valve 120. Power to the solenoid is lost as the electrical circuit fails, and solenoid-activated valve 120 is moved to the “open” position. As valve 120 opens in response to the failed circuit, water is communicated from municipal side 122 at street pressure to system side 124 (as shown by arrow 144 in FIG. 1). Stated differently, the water pressure in municipal side 122 and the water pressure in system side 124 are equalized, and system 100 is “charged”. Water is delivered to sprinkler heads 102-108 in preparation for extinguishing the fire in the structure.

Of note, water is only dispensed through sprinkler heads 102-108 when two conditions are met. First, one or more cover plates, e.g. cover plate 222, partially or completely separate from their corresponding sprinkler head casings, e.g. casing 218, in response to fire-generated heat. Second, temperature monitor 231 detects a predetermined temperature. The predetermined temperature may be the same temperature as that required to melt solder joint 230, or it may be a different temperature. In at least one embodiment, the predetermined temperature is approximately 165° F. The redundancy of sensors in system 100 allows for several operating scenarios, to include: a near-simultaneous charging of system 100 and dispensing of water onto the fire; and, a preliminary charging of system 100, and a subsequent dispensing of water when the predetermined temperature is detected. In this way, water damage to those portions of the structure where no fire is present is prevented or minimized.

In the event of a power outage, solenoid-activated valve 120 opens, creating a water pressure in the system side 124 that is equal to the water pressure on the municipal side 122. When power is restored, valve 120 closes Concurrently, high pressure switch 136 is activated, thereby reminding an attendant or homeowner to open valve 134 and return system 100 to the desired static pressure level, as herein disclosed above.

In one embodiment, concealed sprinkler heads 102-108 may be used with a dry system, where activation of switch 232 begins the process of charging system 100 with water. For example, solenoid-activated valve 120 may initially be powered closed to prevent water from entering system side 124, which is dry and maintained at near ambient air pressure. Activation of switch 232 opens solenoid-activated valve 120 and an air outlet (not shown), so that system side 124 is charged with water. Sprinkler heads 102-108 are activated individually when heat or pressure seals are broken in response to the detection of a predetermined temperature.

Although systems disclosed herein have been described as charged with water, one skilled in the art will understand that numerous fire suppression agents other than water may be used. Such fire suppression agents may include, without limitation, foams and gases (e.g., carbon dioxide, argon, nitrogen and mixtures thereof).

Variations of the mechanisms and electronics of fire sprinkler system 100 are within the scope of this disclosure. In one embodiment, a plurality of sprinkler heads may be concealed with a single cover plate. In another embodiment, cover plate 222 may be mated with sprinkler head casing 218 by a mechanical and/or electromagnetic device. A heat sensor, such as a thermocouple, may communicate with a microprocessor to disconnect the mechanical and/or electromagnetic mating device at a specified temperature. Activation of a first switch may trigger other mechanical and/or electromagnetic mating devices to disconnect one or more additional cover plates in the sprinkler system.

Certain changes may be made in the fire sprinkler system described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A fire sprinkler system comprising:
a plurality of sprinkler heads disposed at pre-selected locations in a structure;
means for delivering water from a main supply line to the plurality of sprinkler heads;
means for selectively isolating water in the system from water in the main supply line;
means for relieving a water pressure in the system so that the water pressure in the system is less than a water pressure in the main supply line, when the water in the system is isolated from the water in the main supply line; and
means for triggering a release of water from the main supply line to the system in response to heat generated by a fire in the structure.

2. The fire sprinkler system of claim 1, further comprising means for concealing the plurality of sprinkler heads.

3. The fire sprinkler system of claim 1, further comprising alarm means for signaling when the water pressure in the system deviates from a specified value.

4. The fire sprinkler system of claim 1, wherein the means for selectively isolating water in the system from water in the main supply line is a solenoid-activated valve.

5. The fire sprinkler system of claim 4, wherein the means for triggering a release of water from the main supply line to the system further comprises:
a plurality of sprinkler head cover plates, each cover plate mounted to a corresponding sprinkler head; and
a plurality of switches, each switch mated to a corresponding sprinkler head cover plate, the switches in electrical communication with the solenoid-activated valve
wherein the solenoid-activated valve opens in response to separation of a sprinkler head cover plate from a switch, allowing water to flow from the main supply line into the system.

6. A fire sprinkler system comprising:
a plurality of sprinkler heads disposed at pre-selected locations in a structure;
piping for delivering water to the plurality of sprinkler heads;
an isolation valve positioned between the piping and a main supply line, for selectively isolating water in the main supply line from water in the system;
a pressure control mechanism for controlling water pressure in the system, wherein the water pressure in the system is less than water pressure in the main supply line, when the water in the main supply line is isolated from the water in the system; and
a release mechanism for triggering a release of water from the main supply line into the system in response to heat generated by a fire in the structure.

7. The fire sprinkler system of claim 6, further comprising a high/low pressure switch for activating an alarm when the water pressure in the system deviates from a predetermined value.

8. The fire sprinkler system of claim 6, wherein the pressure control mechanism further comprises:
a pressure gauge for monitoring the water pressure of the system; and
a drain valve to drain water from the system.

9. The fire sprinkler system of claim 6, wherein the release mechanism further comprises:
a plurality of sprinkler head cover plates, each sprinkler head cover plate mounted to a corresponding sprinkler head of the plurality of sprinkler heads;
a plurality of switches, each switch mated to a corresponding sprinkler head cover plate, the switches in electrical communication with the isolation valve
wherein the isolation valve opens in response to separation of a sprinkler head cover plate from a switch, allowing water to flow from the main supply line into the system.

10. The fire sprinkler system of claim 9, wherein each switch is compressed between a sprinkler head cover plate and a casing of a corresponding sprinkler head.

11. The system of claim 9, wherein each sprinkler head cover plate is mounted to a corresponding sprinkler head using a temperature sensitive joint.

12. The fire sprinkler system of claim 11, wherein the temperature sensitive joint includes a solder material which melts at a pre-selected temperature.

13. The fire sprinkler system of claim 6, further comprising a temperature monitor for sensing a predetermined temperature.

14. A method for extinguishing a fire in a structure, comprising:
charging a fire extinguishing system in the structure with water;
selectively isolating water in the fire extinguishing system from water in a main supply line;
maintaining water pressure in the fire extinguishing system at a predetermined value which is less than water pressure in the main supply line; and
releasing water from the main supply line into the fire extinguishing system in response to heat generated by a fire in the structure.

15. The method of claim 14, wherein a solenoid-activated valve is used to selectively isolate water in the fire extinguishing system from water in the main supply line.

16. The method of claim 15, wherein the fire extinguishing system includes one or more sprinkler heads having a cover plate in electrical connection with the solenoid-activated valve.

17. The method of claim 16, wherein releasing water from the main supply line further comprises:
separating the cover plate from the sprinkler head in the presence of a fire generated heat of a known temperature; and
opening the solenoid-activated valve to release water from the main supply line into the fire extinguishing system.

18. The method of claim 14, wherein maintaining the water pressure in the fire extinguishing system further comprises:
monitoring the water pressure in the fire extinguishing system; and
releasing water from the fire extinguishing system when the water pressure exceeds a predetermined value.

19. A method for extinguishing a fire in a structure, comprising:
charging a fire extinguishing system in the structure with a fire suppression agent, wherein a static pressure of the fire suppression agent in the fire extinguishing system is less than a static pressure of fire suppression agent in a main supply line;
selectively isolating the fire suppression agent in the fire extinguishing system from the fire suppression agent in the main supply line;
maintaining the static pressure of the fire suppression agent in the fire extinguishing system at a predetermined value; and
releasing fire suppression agent from the main supply line into the fire extinguishing system in response to heat generated by a fire in the structure.

20. The method of claim 19, wherein the fire suppression agent is selected from a group consisting of: water, foams, gasses, and combinations thereof.
